(19) United States
(12) Patent Application Publication
(10) Pub. No.: US 2004/0228270 A1
(43) Pub. Date: Nov. 18, 2004

(54) Method of processing an OFDM signal and OFDM receiver using the same

(76) Inventors: Hou-Shin Chen, Taipei (TW); Wei-Hung He, Taipei (TW); Shiou-Hung Chen, Taipei (TW)

Correspondence Address: BIRCH STEWART KOLASCH & BIRCH, PO BOX 747, FALLS CHURCH, VA, 22040-0747, US

(21) Appl. No.: 10/436,138

(22) Filed: May 13, 2003

(51) Int. Cl. H04J 11/00

(52) U.S. Cl. 370/210

(57) ABSTRACT

A method of processing an OFDM signal to determine its FFT mode or the number of carriers without regard to the pilot pattern. The OFDM receiver determines autocorrelation functions corresponding to a plurality of possible FFT modes and variation-to-average ratios of these autocorrelation functions, respectively. The correct FFT mode is determined based on the variation-to-average ratios. In addition, a novel time and frequency synchronization scheme is performed after the correct FFT mode is detected.

### BACKGROUND OF THE INVENTION

1. Field of the Invention

The present invention relates to a Terrestrial Digital Video Broadcasting (DVB-T) system, and in particular to a broadband DVB-T receiver using concatenated-coded Orthogonal Frequency Division Multiplexing (OFDM) technology, which provides a system-independent mode detection scheme and performs required time and frequency synchronization.

2. Description of the Related Art

DVB-T is a next-generation standard for wireless broadcast of Motion Picture Experts Group 2 (MPEG-2) video. In order to provide the high data rate required for video transmission, concatenated-coded OFDM have been adopted into the DVB-T standard.

OFDM is a multi-carrier communication scheme to deal with data transmission over multi-path channels. In OFDM, each carrier used for transmission has rectangular waveform, which can be easily formed by Inverse Fast Fourier Transform (IFFT) in a transmitter and reversed by FFT in a receiver. In addition, the carriers of an OFDM signal are orthogonal to each other. FIG. 1 (Prior Art) illustrates an example of spectra of a multitude of carriers in an OFDM signal. As shown in FIG. 1, the frequency spacing 1/Tu of these carriers is chosen in such a way that at the frequency where one of the carriers is evaluated, such as carrier 1, all other carriers are zero. Thus, the information transmitted over the different carriers can be properly separated.

In order to reduce inter-symbol interference (ISI) due to multi-path channels, the OFDM symbols are extended by individually copying a tail portion of the OFDM symbol to precede the same one. FIG. 2 (Prior Art) is a diagram illustrating the structure of OFDM symbols in an OFDM signal. As shown in FIG. 2, a tail portion 10a of the symbol X is copied to be a head of the symbol X, which is called a guard interval 20a, where the duration of the usable part of a symbol is set to be Tᵤ and the duration is of the guard interval 20a is set to be Δ. If the guard interval 20a is longer than the maximum channel delay, all reflections of previous OFDM symbols can be removed and the orthogonality is preserved.

In order to cope with a multitude of propagation conditions encountered in the wireless broadcast channel, many parameters of OFDM for the DVB-T system can be dynamically changed according to channel conditions. In particular, the number of OFDM carriers, which can be either 2048 (2k mode) or 8196 (8k mode), and the guard interval value, which can be ¼, ⅛, 1/16 or 1/32, should be properly determined so that the desired trade-off can be struck between ISI mitigation capability and robustness against Doppler-spread. As a result, a “mode detection” that detects both the number of carriers and the guard interval value in the transmitted OFDM symbol is required in a DVB-T receiver.

The carriers of the transmitted OFDM symbols in a DVB-T system can be categorized into four types, including data carriers, scattered pilot carriers, continual pilot carriers and Transmission Parameter Signaling (TPS) carriers. FIG. 3 (Prior Art) is a diagram illustrating the allocation of these kinds of carriers in the OFDM symbols of a DVB-T signal. It is noted that, in the DVB-T standard, only 1705 carriers are active in the 2k mode and only 6817 carriers are valid in the 8k mode. As shown in FIG. 3, the data carriers are used for ordinary data transmission. The scattered pilot carriers are allocated in different carriers in different symbols and the continual pilot carriers are allocated every 48 carriers in these symbols. The TPS carriers convey various transmission parameters, such as modulation information, hierarchical information, guard intervals, inner code rates, transmission modes (such as 2k or 8k modes) and so on, from the DVB-T transmitter to the DVB-T receiver. More details about the DVB-T standard can be found in the Digital Video Broadcasting standards.

As described above, the mode detection that detects the correct FFT mode and the selected guard interval value of a transmitted DVB-T signal is essential since other processing operations must be performed after the correct number of carriers and the length of the guard interval or cyclic prefix have been both determined. The conventional scheme for mode detection is carried out by detecting positions of pilot subsymbols, which, however, requires the knowledge of the pilot pattern in advance and is therefore system-dependent. It is also noted that the mode information carried by the TPS carriers cannot be located and interpreted before the correct mode has been detected. Thus, a blind mode detection scheme which is system-independent is necessary for a DVB-T receiver.

In addition to mode detection, time and frequency synchronization are also required in any OFDM transmission system. Time synchronization finds out the beginning of a received OFDM symbol, that is, an initial sample of a first OFDM symbol in an OFDM-based signal, to synchronize the time scales of the transmitter and the receiver. Frequency synchronization eliminates the frequency deviation between oscillators of the transmitter and the receiver. After the correct mode is detected, an efficient and accurate scheme for time and frequency synchronization has to be taken prior to succeeding manipulation.

### SUMMARY OF THE INVENTION

Accordingly, an object of the present invention is to provide an OFDM receiver, especially a DVB-T receiver, which can initially detect the correct FFT mode and the guard interval value of a received OFDM signal without knowledge of the pilot pattern.

Another object of the present invention is to provide a method of processing an OFDM or DVB-T signal, which can initially detect the correct mode without knowledge of the pilot pattern and efficiently perform time and frequency synchronization.

In a preferred embodiment, the present invention provides a method of processing an OFDM signal transmitted by an OFDM transmitter to determine the correct FFT mode and the guard interval length in an OFDM receiver. Preferably, the OFDM signal can be a DVB-T signal for video transmission. The OFDM signal is first converted to a digital received signal. There are several possible FFT modes and guard interval lengths defined in the OFDM receiver. In the DVB-T case, the possible FFT modes include the 2k mode and the 8k mode. Next, the OFDM receiver determines autocorrelation functions of the digital received signal corresponding to these possible FFT modes, respectively. In addition, variation-to-average ratios of these autocorrelation functions are calculated, respectively. Preferably, the variation-average ratio is a ratio of a variance and an average of the corresponding autocorrelation function. If the proper FFT mode is chosen, its variation-to-average ratio is the highest due to the cyclic nature of OFDM symbols. Thus, one of the possible FFT modes with the largest variation-to-average ratio is chosen as the correct mode. In addition, the guard interval value defined in the OFDM signal can be determined by the autocorrelation function. First, a plurality of ideal waveforms of the autocorrelation function using a plurality of possible guard interval values are respectively determined. Next, a plurality of cross-correlation functions of the ideal waveforms and the autocorrelation function corresponding to the correct FFT mode are also calculated. Next, the maximal samples of the cross-correlation functions corresponding to the possible guard interval values are estimated. If the proper guard interval value is chosen, the maximal sample of its cross-correlation function is the highest due to the similarity between the true autocorrelation function and the corresponding ideal waveform. Thus, one of the possible guard interval values is chosen as the correct one according to the maximal samples of their cross-correlation functions.

Since such scheme does not utilize the pilot information, the mode-detection method of the present invention is system-independent.

Using the detected FFT mode and guard interval length, the OFDM receiver can further perform the time and frequency synchronization. With respect to the time synchronization, an average autocorrelation function of the autocorrelation function corresponding to the correct FFT mode is computed over a length of observed OFDM symbols of the digital received signal. Thus, an initial sample index of a first OFDM symbol among the observed OFDM symbols of the digital received signal can be designated according to the average autocorrelation function. With respect to the frequency synchronization, the frequency offset between oscillators of the OFDM transmitter and the OFDM receiver is assumed as (K+b)/Tᵤ, where K is an integer and −0.5≦b<0.5, and 1/Tᵤ represents a carrier spacing of the digital received signal. An estimate for the parameter b can be determined using phase information of the average autocorrelation function with respect to the initial sample index of the first OFDM symbol. An estimate for the parameter K can be determined by the property of the continual pilot carriers in the DVB-T system. An average correlation coefficient of continual pilot carriers in two consecutive OFDM symbols of the digital received signal over a continual pilot carrier index is first determined. The estimate for the parameter K is determined by an index of the average correlation coefficient, which maximizes the average correlation coefficient. The frequency compensation for the digital received signal is performed using the frequency offset determined by the estimates for b and K.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates an example of spectra of a multitude of carriers in an OFDM signal;

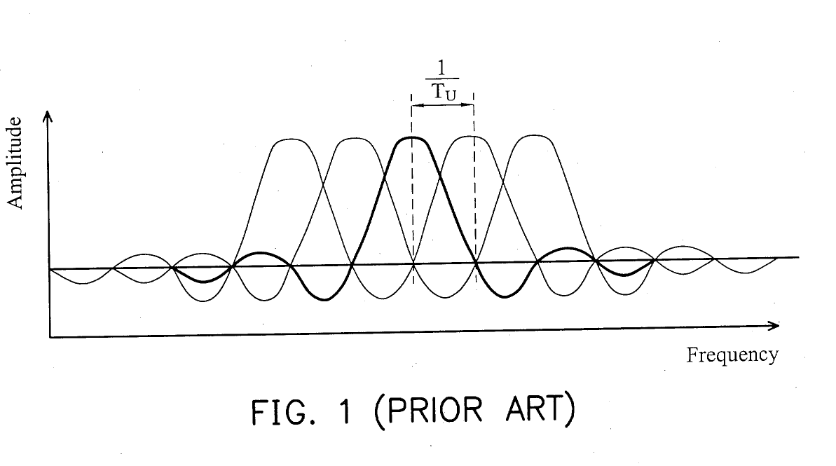

FIG. 2 is a diagram illustrating the structure of OFDM symbols in an OFDM signal;

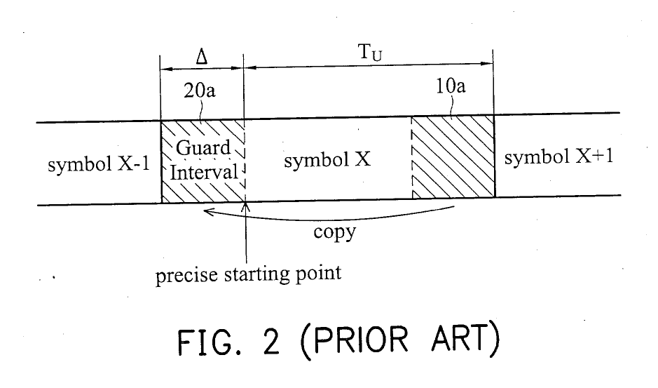

FIG. 3 is a diagram illustrating the allocation of different kinds of carriers in the symbols of a DVB-T signal;

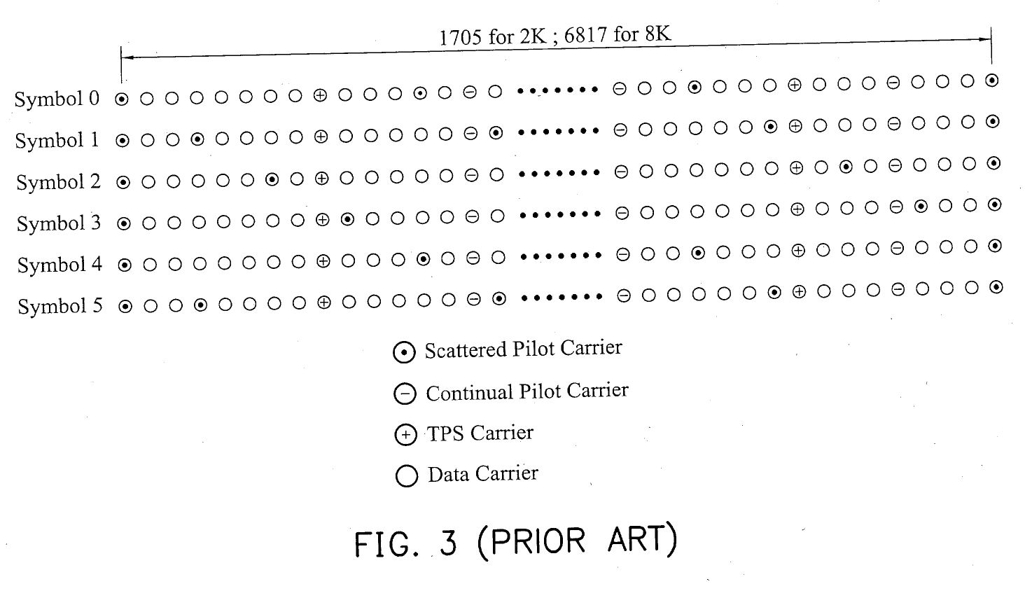

FIG. 4 is a block diagram of a DVB-T receiver in accordance with the preferred embodiment of the present invention;

FIG. 5 is a diagram showing the autocorrelation functions corresponding to the 2k mode and the 8k mode when a 2k-mode signal is transmitted;

FIG. 6 is a diagram illustrating the waveforms of the autocorrelation functions in terms of four possible guard interval values of a DVB-T signal;

FIG. 7 is a flowchart showing the blind mode detection scheme of the present invention;

FIG. 8 is a flowchart showing the time synchronization scheme of the present invention;

FIG. 9 is a diagram showing a frequency offset Δf between transmitted and received signals in the present invention;

FIG. 10 is a flowchart showing the frequency synchronization scheme of the present invention; and

FIG. 11 is a flowchart showing the modified frequency synchronization scheme of the present invention.

### DETAILED DESCRIPTION OF THE INVENTION

The present invention discloses a blind mode detection scheme, which is system-independent, to determine the correct mode of an OFDM signal transmitted by a DVB-T transmitter or other OFDM transmitters. In the preferred embodiment, a DVB-T receiver is used as an example for explaining the mode detection scheme and the time and frequency synchronization schemes in the present invention. The mode detection scheme, however, is not limited in the DVB-T application and can be applied to other OFDM systems.

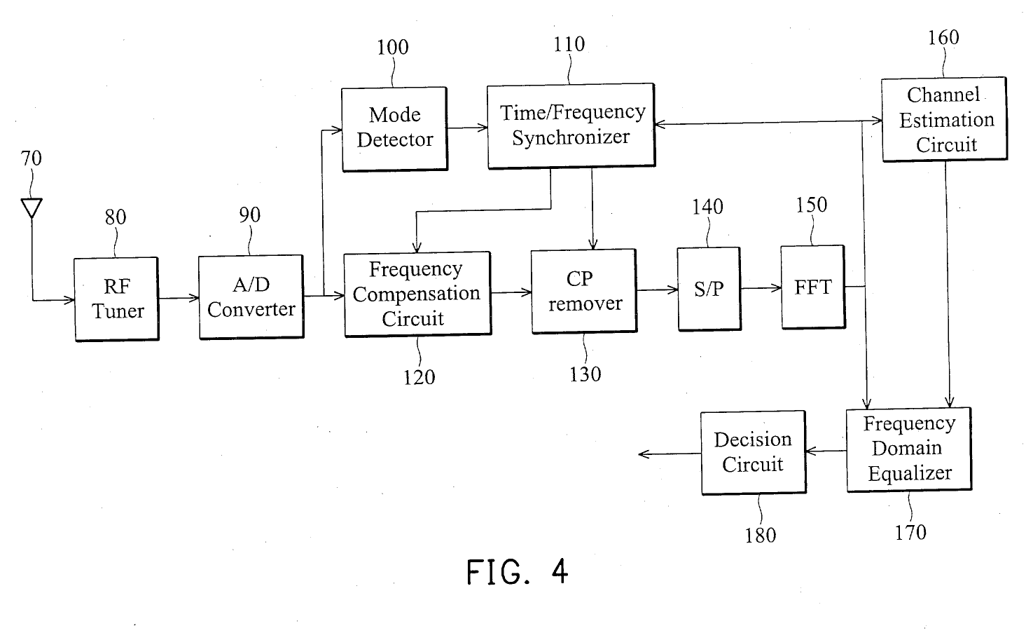

FIG. 4 is a block diagram of a DVB-T receiver in accordance with the preferred embodiment of the present invention. As shown in FIG. 4, the DVB-T receiver includes an antenna 70, a RF tuner 80, an analog-to-digital converter 90, a mode detector 100, a time/frequency synchronizer 110, a frequency compensation circuit 120, a Cyclic Prefix (CP) remover 130, a serial-to parallel converter 140, a FFT unit 150, a channel estimation circuit 160, a frequency domain equalizer 170 and decision circuit 180.

A DVB-T signal is first received by antenna 70 and processed by RF tuner 80. Then the received DVB-T signal is converted to a digital received signal r[n] by A/D converter 90. The digital received signal r[n] is first fed to the mode detector 100 and the time/frequency synchronizer 110 to determine the FFT mode (2k or 8k mode), the guard interval value, optimal timing and carrier frequency offset. After the correct mode is detected, the frequency compensation circuit 120 uses the frequency offset estimated by the time/frequency synchronizer 110 to deal with the digital received signal r[n]. In addition, the CP remover 130 uses the optimal timing information determined by the time/frequency synchronizer 110 to remove the CP (or called the guard interval) of the digital received signal r[n]. The resulted signal is then serial-to-parallel converted by S/P converter 140 and transformed into the frequency domain using FFT unit 150. Channel estimation circuit 160 estimates the channel transfer function and Frequency domain equalizer 170 performs the frequency domain equalization. Finally, the decision circuit 180 recovers the transmitted symbols of the digital received signal.

Mode detection performed by mode detector 100 and time/frequency synchronization performed by synchronizer 110 are main issues in the preferred embodiment, described in detail as follows.

Mode Detection

In the preferred embodiment, blind mode detection, which is performed in the absence of the pilot pattern and therefore system-independent, is adopted to determine the correct mode of the digital received signal r[n]. The mode detector 100 detects the correct number of carriers and the proper guard interval value by exploiting the cyclic nature of OFDM symbols. In the DVB-T system, two possible FFT modes, namely 2k and 8k, can be utilized for data transmission. In addition, four possible guard interval values, including ¼, ⅛, 1/16 and 1/32, can be used to determine the length of the cyclic prefix. The goal of the mode detector 100 is to choose the correct FFT mode from the two FFT modes and to determine the proper guard interval value.

Mathematically, the autocorrelation function of a signal with finite energy gives a measure of similarity or coherence between a signal and a delayed version of the signal. The autocorrelation function of the digital received signal r[n] can, therefore, exhibit the similarity between OFDM symbols. In the preferred embodiment, the autocorrelation functions of the digital received signal r[n] corresponding to the possible FFT modes are defined as:

$${x}_{i} [ n ] = \frac{1}{{N}_{i}} {\sum }_{j = 0}^{{N}_{i} / {Q}^{- 1}} r [ n - j ] {r}^{*} [ n - j - {N}_{i} ] \qquad ( 1 )$$

where the index i indicates the FFT mode, namely the 2k or 8k mode and Q is an integer. Nᵢ is the number of carriers of the corresponding FFT mode. Thus, Nᵢ is 2048 for the 2k mode and 8192 for the 8k mode. Apparently, the autocorrelation function shown in equation (1) can indicate the similarity of subsymbols r[n-j] and r[n-j-Nᵢ] separated by Nᵢ. It is noted that the format of the autocorrelation function shown in equation (1) is not intended to limit the scope of the present invention.

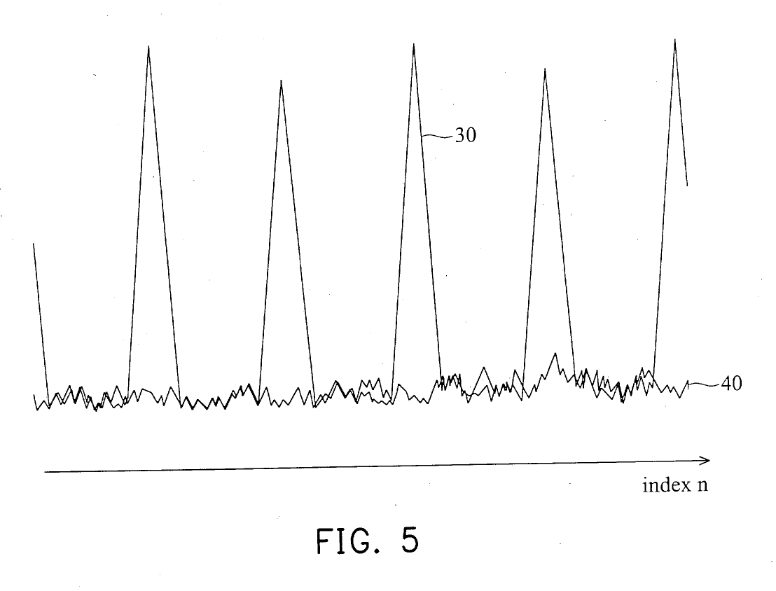

Due to the cyclic nature of OFDM symbols, periodic peaks can be observed in the autocorrelation function xᵢ[n] only when the Nᵢ is set to the correct value. The autocorrelation function appears as a noise-like waveform when an incorrect value of Ni is employed. FIG. 5 is a diagram showing the autocorrelation functions corresponding to the 2k mode and the 8k mode when a 2k-mode signal is transmitted, where numeral 30 indicates the 2k-mode case and numeral 40 indicates the 8k-mode case. As shown in FIG. 5, the autocorrelation function of the correct 2k mode shows periodic peaks, such that those of the incorrect 8k mode look like noise.

According to FIG. 5, the relative dynamic ranges of the autocorrelation functions x₂ₖ[n] and x₈ₖ[n] can be regarded as a measure of difference between correct and incorrect FFT modes. A variation-to-average ratio, which is a ratio of a variance and an average of the autocorrelation function in the preferred embodiment, is used to examine the relative dynamic range and can be expressed as:

$${M}_{i} = \frac{⟨ {\vert {x}_{i} [ n ] \vert}^{2} ⟩ - {⟨ \vert {x}_{i} [ n ] \vert ⟩}^{2}}{⟨ \vert {x}_{i} [ n ] \vert ⟩} \qquad ( 2 )$$

where the function <>denotes time-averaging over a number of samples. Obviously, the variation-to-average ratio of the autocorrelation function corresponding to the correct FFT mode is the larger one. Thus, the transmission mode can then be detected as follows:

î=argmaxMᵢ (3)

where arg( ) denotes an argument function for determining the index (or mode) of the maximal variation-to-average ratio.

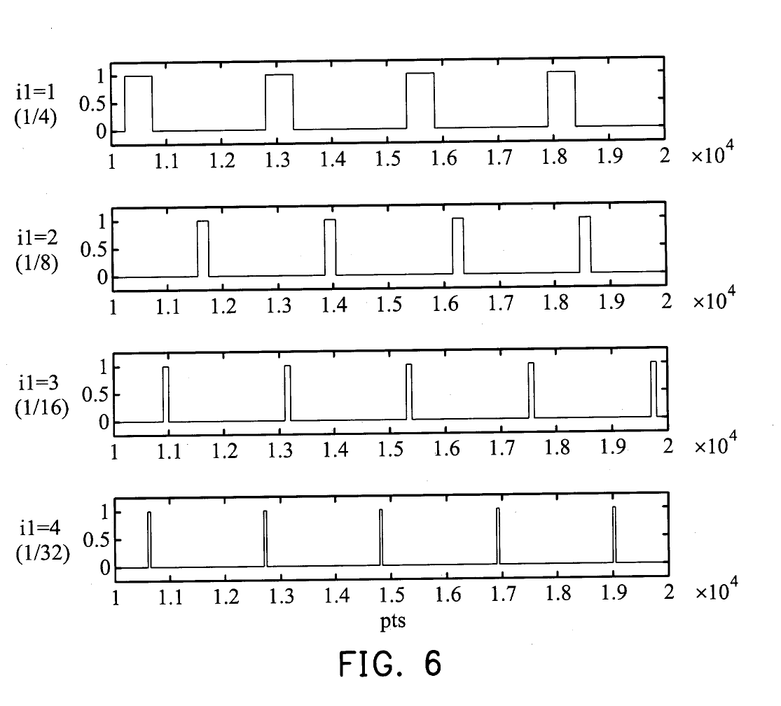

As well, the autocorrelation function determined in equation (1) can be applied to determine the proper guard interval value of the digital received signal. According to the property of the autocorrelation function, the waveform of the autocorrelation function is similar to the square wave. In addition, the duty cycle and the duration of its waveform depend on the guard interval length of the digital received signal. FIG. 6 is a diagram illustrating the waveforms of the autocorrelation functions in terms of four possible guard interval values, namely, ¼, ⅛, 1/16 and 1/32. The ideal waveform of the autocorrelation function, denoted by yᵢ₁[k], is a periodic square wave and can be expressed as:

$${y}_{i1} [ k ] = \{ \begin{matrix}1 & , aN ( 1 + \frac{1}{{2}^{i1 + 1}} ) \leq k < \frac{N}{{2}^{i1 + 1}} + aN ( 1 + \frac{1}{{2}^{i1 + 1}} ) , a ∈ Z \\ 0 & otherwise\end{matrix} \qquad ( 4 )$$

where N is the number of carriers and index i1=1, 2, 3 or 4 representing the guard interval value ¼, ⅛, 1/16 or 1/32, respectively.

The straight-forward scheme for detecting the guard interval value is to calculate a cross-correlation function of the autocorrelation function x[n] and different ideal autocorrelation functions as shown in FIG. 6. The cross-correlation function can be expressed as:

$${B}_{i1} [ n ] = \frac{1}{{c}^{′} N ( 1 + \frac{1}{{2}^{i1 + 1}} )} {\sum }_{j = 0}^{{c}^{′} N ( 1 + \frac{1}{{2}^{i1 + 1}} )} x [ j ] {y}_{i1} [ n - j ] , 0 \leq n < N ( 1 + \frac{1}{{2}^{i1 + 1}} ) \qquad ( 5 )$$

where c′ is a positive integer and represents the observation length. Thus, the correct guard interval value (or the corresponding index i1) can be determined by the maximal value of the cross-correlation function Bᵢ₁[n] over the indices n and i1.

According to the above description, the practical process of determining the correct guard interval value can be implemented as follows. At first, the cross-correlation function of the autocorrelation function x[.] and the ideal waveform yᵢₗ[.] is determined. In order to reduce the computing complexity, equation (5) can be modified as:

$${B}_{i1} [ n ] = ( \frac{{2}^{i1 + 1}}{1 + {2}^{i1 = 1}} ) {\sum }_{j = 0}^{N ( 1 + \frac{1}{{2}^{i1 + 1}} )} x [ j ] {y}_{i1} [ n \times b - j ] , 0 \leq n < \frac{N}{b} ( 1 + \frac{1}{{2}^{i1 + 1}} ) \qquad ( 6 )$$

where the parameter b is defined as “block size” and satisfies the condition:

N mod(b×2^{i1 +1})≡0 (7)

Next, a sample position index “nᵢ₁” of the cross-correlation function Bᵢ₁[n] for each ii, which has a maximum value, is determined. That is,

$${n}_{i1} = arg {max}_{n} {B}_{i1} \qquad ( 8 )$$

Using the sample position index “nᵢ₁”, an estimate \hat{B}ᵢ₁ for the similarity of the autocorrelation function and the ideal waveform Yᵢ₁[.] is determined as:

$${\hat{B}}_{i1} [ n ] = ( \frac{{2}^{i1 + 1}}{1 + {2}^{i1 = 1}} ) {\sum }_{j = 0}^{N ( 1 + \frac{1}{{2}^{i1 + 1}} )} x [ j ] {y}_{i1} [ {n}_{i1} \times b - j ] \qquad ( 9 )$$

Finally, the index for the correct guard interval value can be determined since the estimate \hat{b}ᵢ₁ with respect to the correct guard interval value is maximal.

$$\hat{i} 1 = arg {max}_{i1} {\hat{B}}_{i1} \qquad ( 10 )$$

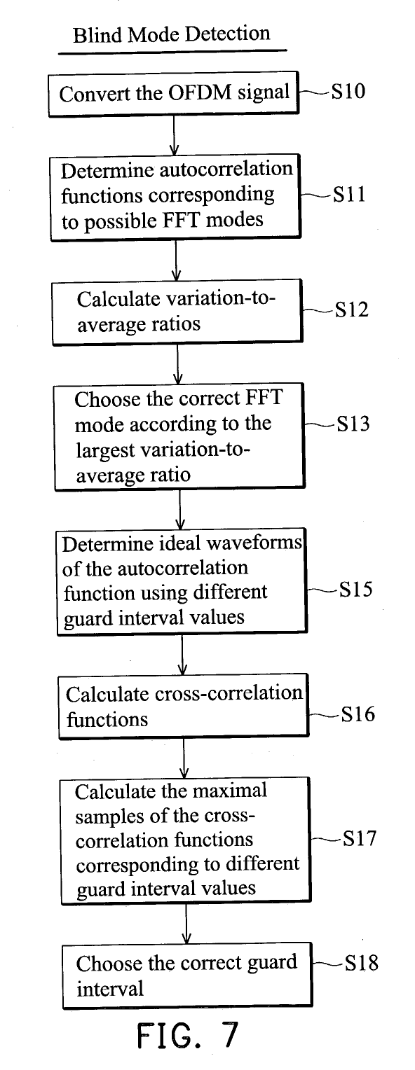

The blind mode detection scheme described above can also be applied to other OFDM system. FIG. 7 is a flowchart showing the blind mode detection scheme in an OFDM receiver in accordance with the present invention. More particularly, steps S11-S13 are used to determine the correct FFT mode and steps S15-S18 are used to determine the correct guard interval value. If there are plural possible FFT modes or carrier numbers employed in the OFDM signal known by the OFDM receiver in advance, then first, the OFDM signal is converted to a digital received signal r[n] for further processing (step S10). Next, a plurality of autocorrelation functions xᵢ[n] of the digital received signal r[n] corresponding to a plurality of these possible FFT modes are determined using equation (1) or the like (step S11), where the symbol “i” is an index of FFT modes. Next, a plurality of variation-to-average ratios Mᵢ of the autocorrelation functions xᵢ[n] are determined using equation (2) or the like, respectively (step S12). Thus, the correct FFT mode can be determined according to the largest variation-to-average ratio among these ratios Mᵢ (step S13).

Some ideal waveforms of the autocorrelation function using different guard interval values are determined (step S15). In the DVB-T case, there are four possible guard interval values, including ¼, ⅛, 1/16 and 1/32, available in the standard specification, and the corresponding ideal waveforms are shown in FIG. 6. Next, the cross-correlation functions of these ideal waveforms and the autocorrelation function corresponding to the correct FFT mode are respectively calculated using equation (6) (step S16). Using equations (8) and (9), the maximal samples of the cross-correlation functions corresponding to different guard interval values can be calculated and estimated (step S17). Finally, the correct guard interval value can be determined according to the largest sample among these maximal samples \hat{B}ᵢ, (step S18).

As described above, the blind mode detection scheme of the present invention does not utilize the pilot information of the received OFDM signal, which implies that such scheme is system-independent.

Time Synchronization

After the transmission mode is detected, time and frequency synchronization is next performed by the time/frequency synchronizer 110. In the proposed DVB-T receiver, the boundary between successive OFDM symbols is acquired using the following time synchronization algorithm.

According to FIG. 5, the autocorrelation function xᵢ[n] corresponding to the correct FFT mode for blind mode detection exhibits the periodic property based on the OFDM symbols and can be exploited for time synchronization. In the preferred embodiment, an average autocorrelation function of the autocorrelation function corresponding to the detected FFT mode in blind mode detection over a number of observed OFDM symbols is defined as:

$$\overline{x} [ n ] = \frac{1}{L} {\sum }_{l = - 0}^{L - 1} {x}_{\hat{i}} [ n - l {N}_{\hat{i}}^{′} ] \qquad ( 11 )$$

where L is the number of the observed OFDM symbols and N′ is the symbol duration with guard interval. The digital received signal has been frame-synchronized, the optimal timing no, which represents an initial sample index of a first OFDM symbol, is given by

$${n}_{0} = arg {max}_{0 \leq n < {N}_{\hat{i}}^{′}} \vert \overline{x} [ n ] \vert - δ \qquad ( 5 )$$

where the integer δ is a margin that is empirically determined to reduce the sensitivity of this method.

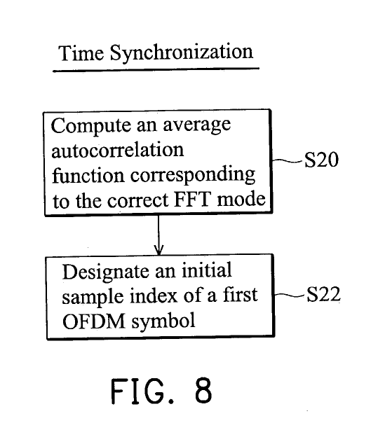

FIG. 8 is a flowchart showing the time synchronization scheme in an OFDM receiver in accordance with the present invention. First, an average autocorrelation function of the autocorrelation function corresponding to the correct FFT mode is computed (step S20). The average autocorrelation function is a time-averaging function over a fixed number of observed OFDM symbols. Thus, the initial sample index of a first OFDM symbol of the digital received signal can be designated according to the average autocorrelation function, especially the maximum of the average autocorrelation function (step S22). The proposed time synchronization scheme employs the autocorrelation function corresponding to the correct FFT mode determined in the blind mode scheme.

Frequency Synchronization

After the optimal timing is determined, the frequency offset between oscillators of the transmitter and the receiver is next estimated by the time/frequency synchronizer 110 and compensated by the frequency compensation circuit 120.

In the proposed DVB-T receiver, the frequency offset Δf is first assumed as:

Δf=(K+b)/Tᵤ (12)

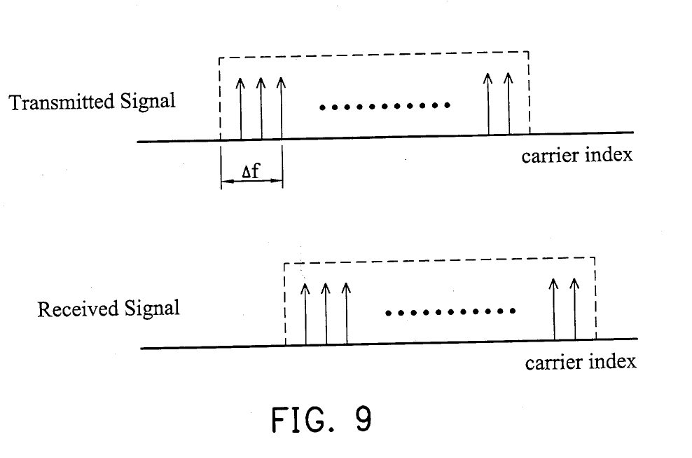

In equation (12), Tᵤ is the duration of a usable part of an OFDM symbol and 1/Tᵤ denotes the carrier spacing of the OFDM signal. The parameters K and b are the integer part and the fractional part, respectively, where −0.5≦b<0.5. FIG. 9 is a diagram showing a frequency offset Δf between transmitted and received signals in the present invention, where the frequency offset Δf is in the units of the carrier spacing 1/Tᵤ. Determining estimates for the parameters K and b are shown as follows.

With respect to the parameter b, it can be verified that the phase difference between a sample in the guard interval (or called cyclic prefix) of a received OFDM symbol and a sample shifted by Tᵤ seconds is roughly −2πb. Thus, the parameter b can be estimated by:

$${b}_{0} = \frac{- 1}{2 π} Arg ( \overline{x} [ {n}_{0} ] ) \qquad ( 13 )$$

where the function Arg(x) denotes the phase angle (modulo 2π) of x. Equation (13) indicates that an estimate b₀ is determined by phase information of the average autocorrelation function \overline{x}[n₀] with respect to the initial sample index of the first OFDM symbol determined in the time synchronization scheme.

In the DVB-T receiver of the preferred embodiment, the parameter K is estimated by the use of the property of continual pilot carriers in the DVB-T signal. Basically, the active carriers of the DVB-T signal are shifted, ignoring the effect of the fractional part b, by K times the carrier spacing 1/Tᵤ. Since the continual pilot carriers of two adjacent symbols in the same carrier index should be highly correlated, an average correlation coefficient ρ(k₀), which is expressed in equation (14), can be utilized to estimate the integer part K.

$$ρ ( {k}_{0} ) = \frac{⟨ R ( j + 1 , {k}_{p} + {k}_{0} ) \cdot {R}^{*} ( j , {k}_{p} + {k}_{0} ) ⟩}{\sqrt{⟨ {\vert R ( j + 1 , {k}_{p} + {k}_{0} ) \vert}^{2} ⟩ ⟨ {\vert R ( j , {k}_{p} + {k}_{0} ) \vert}^{2} ⟩}} \qquad ( 14 )$$

where R(j,k) represents a received subsymbol of the j-th OFDM symbol at the k-th carrier, and the function <>represents an average over the continual pilot carrier index kₚ. It can be verified that the average correlation coefficient p(k₀) is maximized when k₀=K. Thus, an estimate K₀ for the parameter K is given by:

$${K}_{0} = {max}_{{k}_{0}} ρ ( {k}_{0} ) \qquad ( 15 )$$

Therefore, the estimated frequency offset is given by (K₀+b₀)/Tᵤ.

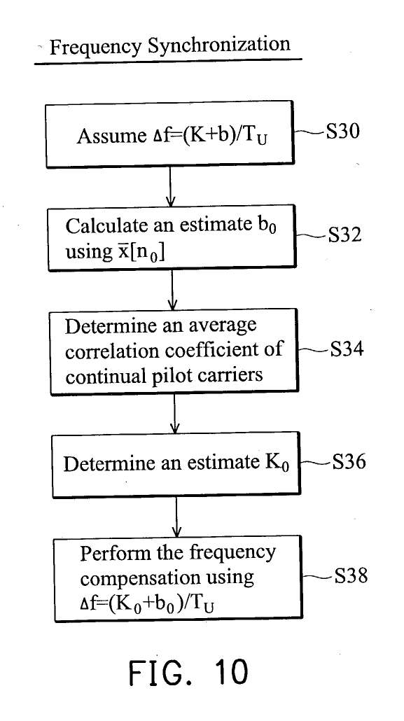

FIG. 10 is a flowchart showing the frequency synchronization scheme of the present invention. First, the frequency offset between oscillators of the OFDM transmitter and the OFDM receiver is set as Δf=(K+b)/Tᵤ (step S30), where K is an integer part and b is a fractional part. The estimate b₀of the fractional part b is calculated using phase information of the average autocorrelation function \overline{x}[n₀] with respect to the initial sample index n₀ of the first OFDM symbol (step S32). In the determination of the estimate K₀of the integer part K, an average correlation coefficient ρ(k) of continual pilot carriers in two consecutive OFDM symbols of the digital received signal over the continual pilot carrier index kₚ is first determined (step S34). When the average correlation coefficient ρ(k₀) is maximized, the index k₀is regarded as an estimate K₀for the parameter K (step S36). Finally, the frequency compensation circuit 120 utilizes the estimated frequency offset Δf=(K₀+b₀)/Tᵤ to perform a frequency compensation for the digital received signal.

Preliminary simulation of the frequency synchronization scheme illustrated in FIG. 10, however, shows that the frequency offset estimation may result in poor performance in the presence of noise when b is close to ±0.5. For example, if K₀+b₀=2.45 and K₀=3, the error in K₀ cannot be completely compensated because b₀≈0.5. In the preferred embodiment, a modified frequency synchronization scheme is illustrated in FIG. 10 to solve this problem.

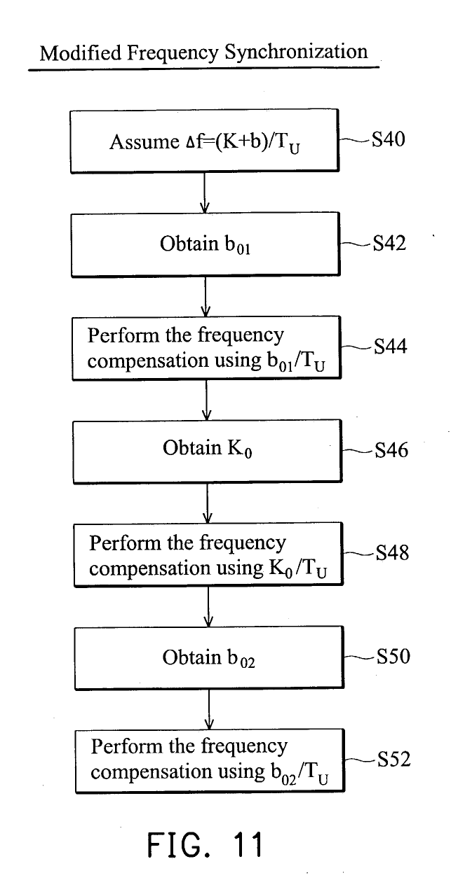

FIG. 11 is a flowchart showing the modified frequency synchronization scheme of the present invention. First, the frequency offset between oscillators of the OFDM transmitter and the OFDM receiver is also set as Δf=(K+b)/Tᵤ (step S40). Next, a first estimate b₀₁ for the parameter b is obtained using equation (7) (step S42). Then the digital received signal is frequency-compensated by b₀₁/Tᵤ Hz to make the residual frequency offset approximately equal to a multiple of the carrier spacing (step S44). Next, a second estimate K₀ for the parameter K is obtained using equations (8) and (9) (step S46), and the digital received signal is then frequency-compensated by K₀/Tᵤ Hz (step S48). Finally, a third estimate b₀₂ for the parameter b is obtained again using equation (7) (step S50) to recover the remaining frequency offset using b₀₂/Tᵤ Hz (step S52).

The advantage of the OFDM or DVB-T receiver of the present invention is that the proposed blind mode detection scheme performs mode detection without regard to knowledge of the pilot pattern of the received signal, which is suitable to practical applications. In addition, using the detected mode, time and frequency synchronization can be easily and efficiently performed in the present invention.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of processing an orthogonal frequency division multiplexing (OFDM) signal in an OFDM receiver, the OFDM signal being transmitted by an OFDM transmitter with a correct FFT mode corresponding to the number of OFDM carriers, comprising the steps of:
converting the OFDM signal to a digital received signal;
determining a plurality of autocorrelation functions of the digital received signal corresponding to a plurality of possible FFT modes;
calculating a plurality of variation-to-average ratios of the autocorrelation functions corresponding to the possible FFT modes; and
choosing one of the possible FFT modes having a largest variation-to-average ratio among the calculated variation-to-average ratios as the correct FFT mode.

2. The method of processing the OFDM signal as recited in claim 1, wherein the OFDM signal is a Terrestrial Digital Video Broadcasting (DVB-T) signal.

3. The method of processing the OFDM signal as recited in claim 1, wherein the autocorrelation function x[ ] corresponding to one of the possible FFT modes is expressed as:
$$x [ n ] = \frac{1}{N} {\sum }_{j = 0}^{N / {Q}^{- 1}} r [ n - j ] {r}^{*} [ n - j - N ]$$
where r[ ] is the digital received signal, Q is an integer and N is the number of the carriers in the corresponding possible FFT mode.

4. The method of processing the OFDM signal as recited in claim 1, wherein the variation-to-average ratio M corresponding to one of the autocorrelation functions is expressed as:
$$M = \frac{⟨ {\vert x [ n ] \vert}^{2} ⟩ - {⟨ \vert x [ n ] \vert ⟩}^{2}}{⟨ \vert x [ n ] \vert ⟩}$$
where x[ ] is the corresponding autocorrelation function.

5. The method of processing the OFDM signal as recited in claim 1, further comprising the steps of:
computing an average autocorrelation function of the autocorrelation function corresponding to the correct FFT mode over a length of OFDM symbols of the digital received signal; and
designating an initial sample index of a first OFDM symbol among the OFDM symbols of the digital received signal according to the average autocorrelation function.

6. The method of processing the OFDM signal as recited in claim 5, wherein the average autocorrelation function is a time-averaging function of the autocorrelation function corresponding to the correct FFT mode over a time period of the length of the OFDM symbols.

7. The method of processing the OFDM signal as recited in claim 5, wherein the initial sample index of the first OFDM symbol is designated based on a maximum of the average autocorrelation function.

8. The method of processing the OFDM signal as recited in claim 5, wherein the OFDM signal is a DVB-T signal and the method further comprises the steps of:
assuming a frequency offset between oscillators of the OFDM transmitter and the OFDM receiver to be (K+b)/Tᵤ, where K is an integer and −0.5≦b<0.5, and 1/Tᵤ represents a carrier spacing of the digital received signal;
calculating a first estimate b₀ for the parameter b using phase information of the average autocorrelation function \overline{x}[n₀] with respect to the initial sample index of the first OFDM symbol;
determining an average correlation coefficient μ(k) of continual pilot carriers in two consecutive OFDM symbols of the digital received signal over a continual pilot carrier index kₚ;
setting an index k₀ as a second estimate K₀ for the parameter K when the average correlation coefficient ρ(kₒ) is maximized; and
performing a frequency compensation for the digital received signal using the frequency offset determined by the first estimate b₀ and the second estimate K₀.

9. The method of processing the OFDM signal as recited in claim 8, wherein the first estimate b₀ is expressed as:
$${b}_{0} = \frac{1}{2 π} Arg ( \overline{x} [ {n}_{0} ] ) .$$

10. The method of processing the OFDM signal as recited in claim 8, wherein the average correlation function ρ(k) is expressed as:
$$ρ ( k ) = \frac{⟨ R ( j + 1 , {k}_{p} + k ) \cdot {R}^{*} ( j , {k}_{p} + k ) ⟩}{\sqrt{⟨ {\vert R ( j + 1 , {k}_{p} + k ) \vert}^{2} ⟩ ⟨ {\vert R ( j , {k}_{p} + k ) \vert}^{2} ⟩}} ,$$
where R(j,k) represents a received subsymbol of the j-th OFDM symbol at the k-th carrier, and the symbol <> represents an average over the continual pilot carrier index kₚ.

11. The method of processing the OFDM signal as recited in claim 5, wherein the OFDM signal is a DVB-T signal and the method further comprises the steps of:
assuming a frequency offset between oscillators of the OFDM transmitter and the OFDM receiver to be (K+b)/Tᵤ, where K is an integer and −0.5≦b<0.5, and 1/Tᵤ represents a carrier spacing of the digital received signal;
obtaining a first estimate b₀₁ for the parameter b;
performing a first frequency compensation for the digital received signal using a first frequency offset estimate b₀/Tᵤ;
obtaining a second estimate K₀ for the parameter K; performing a second frequency compensation for the digital received signal using a second frequency offset estimate K₀/Tᵤ;
obtaining a third estimate b₀₂ for the parameter b;
performing a third frequency compensation for the digital received signal using a third frequency offset estimate b₀₂/Tᵤ.

12. The method of processing the OFDM signal as recited in claim 1, further comprises the steps of:
determining a plurality of ideal waveforms of the autocorrelation function using a plurality of possible guard interval values, respectively;
calculating a plurality of cross-correlation functions of the ideal waveforms and the autocorrelation function corresponding to the correct FFT mode, respectively;
calculating, respectively, maximal samples of the cross-correlation functions corresponding to the possible guard interval values; and
choosing one of the possible guard interval values having a largest maximal sample among the maximal samples as a correct guard interval value.

13. An orthogonal frequency division multiplexing (OFDM) receiver, comprising:
a converter for converting a received OFDM signal into a digital received signal; and
a mode detector for detecting a correct FFT mode of the received OFDM signal indicating the number of OFDM carriers by determining a plurality of autocorrelation functions of the digital received signal corresponding to a plurality of possible FFT modes, calculating a plurality of variation-to-average ratios of the autocorrelation functions corresponding to the possible FFT modes, and choosing one of the possible FFT modes having a largest variation-to-average ratio among the calculated variation-to-average ratios as the correct mode.

14. The OFDM receiver as recited in claim 13, wherein the received OFDM signal is a Terrestrial Digital Video Broadcasting (DVB-T) signal.

15. The OFDM receiver as recited in claim 13, wherein the autocorrelation function x[ ] corresponding to one of the possible FFT modes is expressed as:
$$x [ n ] = \frac{1}{N} {\sum }_{j = 0}^{N / {Q}^{- 1}} r [ n - j ] {r}^{*} [ n - j - N ]$$
where r[ ] is the digital received signal, Q is an integer and N is the number of the carriers in the corresponding possible FFT mode.

16. The OFDM receiver as recited in claim 13, wherein the variation-to-average ratio M corresponding to one of the autocorrelation functions is expressed as:
$$M = \frac{⟨ {\vert x [ n ] \vert}^{2} ⟩ - {⟨ \vert x [ n ] \vert ⟩}^{2}}{⟨ \vert x [ n ] \vert ⟩}$$
where x[ ] is the corresponding autocorrelation function.

17. The OFDM receiver as recited in claim 13, wherein the mode detector detect a correct guard interval value of the received OFDM signal by determining a plurality of ideal waveforms of the autocorrelation function using a plurality of possible guard interval values, calculating a plurality of cross-correlation functions of the ideal waveforms and the autocorrelation function corresponding to the correct FFT mode, calculating maximal samples of the cross-correlation functions corresponding to the possible guard interval values and choosing one of the possible guard interval values having a largest maximal sample among the maximal samples as the correct guard interval value

18. The OFDM receiver as recited in claim 13, further comprising:
a synchronizer for determining an initial sample index of a first OFDM symbol among a plurality of OFDM symbol of the received OFDM signal using a time-averaging autocorrelation function of the autocorrelation function corresponding to the correct FFT mode over the OFDM symbols of the digital received signal.

19. The OFDM receiver as recited in claim 18,
wherein the OFDM signal is a DVB-T signal;
wherein the synchronizer further determines a frequency offset (K+b)/Tᵤbetween oscillators of the OFDM transmitter and the OFDM receiver, in which 1/Tᵤ represents a carrier spacing of the digital received signal;
wherein a first estimate for the parameter b is determined using phase information of the average autocorrelation function with respect to the initial sample index of the first OFDM symbol;
wherein a second estimate for the parameter K is determined by an index of an average correlation coefficient ρ(k) of continual pilot carriers in two consecutive OFDM symbols of the digital received signal when the average correlation coefficient is maximized; and
wherein the OFDM receiver further comprises a frequency compensation circuit, coupled to the synchronizer and the converter, for compensating the digital received signal using the frequency offset determined by the first estimate and the second estimate.

20. A terrestrial digital video broadcasting (DVB-T) receiver for processing an input signal with a correct FFT mode corresponding to the number of OFDM carriers, the correct FFT mode being a 2k mode or an 8k mode, comprising:
a converter for converting the input signal into a digital received signal; and
a mode detector, coupled to the converter, for detecting the correct FFT mode of the input signal by determining first and second autocorrelation functions of the digital received signal corresponding to the 2k mode and the 8k mode and calculating first and second variation-to-average ratios of the first and second autocorrelation functions, respectively, the correct FFT mode being the 2k mode when the first variation-to-average ratio is larger than the second variation-to-average ratios, and the correct FFT mode being the 8k mode when the second variation-to-average ratio is larger than the first variation-to-average ratios.

21. The DVB-T receiver as recited in claim 20, wherein the first and second autocorrelation functions xᵢ[n] are expressed as:
$${x}_{i} [ n ] = \frac{1}{{N}_{i}} {\sum }_{j = 0}^{{N}_{i} / {Q}^{- 1}} r [ n - j ] {r}^{*} [ n - j - {N}_{i} ]$$
where the index i is 2k or 8k, r[ ] is the digital received signal, Q is an integer and Nᵢ is 2048 for the 2k mode, or 8192 for the 8k mode.

22. The DVB-T receiver as recited in claim 20, wherein the first and second variation-to-average ratios Mᵢ are expressed as:
$${M}_{i} = \frac{⟨ {\vert {x}_{i} [ n ] \vert}^{2} ⟩ - {⟨ \vert {x}_{i} [ n ] \vert ⟩}^{2}}{⟨ \vert {x}_{i} [ n ] \vert ⟩}$$
where the index i denotes 2k or 8k.
